(19) United States
(12) Patent Application Publication
(10) Pub. No.: US 2012/0060614 A1
(43) Pub. Date: Mar. 15, 2012

(54) IMAGE SENSING DEVICE

(75) Inventors: Masahiro YOSHIDA, Osaka (JP); Tomoki Oku, Osaka City (JP); Tatsuo Koga, Daito City (JP); Kazuma Hara, Daito City (JP); Hisatoshi Oomae, Nishinomiya City (JP); Hideto Shimaoka, Uji City (JP)

(73) Assignee: SANYO Electric Co., Ltd., Moriguchi City (JP)

(21) Appl. No.: 13/228,507

(22) Filed: Sep. 9, 2011

(30) Foreign Application Priority Data
Sep. 9, 2010 (JP) 2010-202311

(51) Int. Cl. G01N 29/00

(52) U.S. Cl. 73/649

(57) ABSTRACT

An image sensing device according to the present invention includes: an optical portion that is driven to form an optical image in any state; a sensor portion that acquires, as an image signal, the optical image formed by the optical portion; a sound collection portion that acquires an acoustic signal by collecting sound; an image sensing environment determination portion that determines an image sensing environment which is an environment under which the sensor portion acquires the image signal; and an operation determination portion that determines, based on the image sensing environment determined by the image sensing environment determination portion, at least one of a drive speed of the optical portion and a method of processing the acoustic signal acquired by the sound collection portion when the optical portion is driven.

This nonprovisional application claims priority under 35 U.S.C. §119(a) on Patent Application No. 2010-202311 filed in Japan on Sep. 9, 2010, the entire contents of which are hereby incorporated by reference.

### BACKGROUND OF THE INVENTION

1. Field of the Invention

The present invention relates to an image sensing device that senses images and collects sound.

2. Description of Related Art

Conventionally, image sensing devices, such as digital cameras, that can sense images and collect sound are widely used. Most of these image sensing devices include a drive portion that drives an optical system such as lenses. The optical system is driven by the drive portion, and thus it is possible to change the angle of view (the state of zoom) to a desired state and to achieve focus.

When the drive portion drives the optical system, this produces drive sound (such as sound produced by the movement of a lens or the like or by the friction and collision of an enclosure or sound produced by a power source such as a motor). Since the drive sound can be recognized by a user as noise, it is preferable to reduce the drive sound.

Hence, an image sensing device is proposed that decreases the drive speed of an optical system to reduce the drive sound. Since the drive speed of the optical system is decreased and thus the speed of zoom, focusing or the like is reduced, the operability and the convenience of the image sensing device are degraded. Therefore, in such an image sensing device, electronic zoom is performed before optical zoom, and thus the operability and the convenience of the image sensing device are prevented from being degraded.

However, in the image sensing device described above, since electronic zoom is performed each time zoom is conducted, an image is frequently degraded by the electronic zoom.

A special device (for example, an ultrasonic motor) that produces small drive sound is employed as a power source of a drive portion, and thus it is possible to reduce the drive sound. However, the provision of the special device increases the size of the image sensing device, complicates the image sensing device and increases its power consumption and cost.

The drive sound component of acoustic signals obtained by collecting sound can also be reduced by performing processing on the acoustic signals. However, the processing may degrade even the components of sound that a user wants to collect in the acoustic signal; depending on the state of the collected sound (the state of the acoustic signals), the effects of the processing may fail to be sufficiently obtained.

### SUMMARY OF THE INVENTION

An object of the present invention is to provide an image sensing device that adaptively reduces the effects of drive sound.

To achieve the above object, according to the present invention, there is provided an image sensing device including: an optical portion that is driven to form an optical image in any state; a sensor portion that acquires, as an image signal, the optical image foamed by the optical portion; a sound collection portion that acquires an acoustic signal by collecting sound; an image sensing environment determination portion that determines an image sensing environment which is an environment under which the sensor portion acquires the image signal; and an operation determination portion that determines, based on the image sensing environment determined by the image sensing environment determination portion, at least one of a drive speed of the optical portion and a method of processing the acoustic signal acquired by the sound collection portion when the optical portion is driven.

Alternatively, in the image sensing device configured as described above, the image sensing environment determination portion determines the image sensing environment based on at least one of the acoustic signal, the image signal and an instruction input by a user, and the operation determination portion determines, based on the image sensing environment determined by the image sensing environment determination portion, at least one of the drive speed of the optical portion and the method of processing the acoustic signal that reduces a drive sound component of the acoustic signal produced when the optical portion is driven.

With the configuration described above, it is possible to reduce the possibility that the drive sound component of the acoustic signal is easily recognized by the user.

Alternatively, in the image sensing device configured as described above, an acoustic processing portion that processes the acoustic signal is further included, and, as the image sensing environment determination portion determines that a signal level of the acoustic signal is low, the operation determination portion makes a determination such that the acoustic processing portion significantly reduces the drive sound component from the acoustic signal.

With the configuration described above, when the sound that the user wants to collect is unlikely to be included in the acoustic signal, it is possible to reduce the possibility that the drive sound component of the acoustic signal is easily recognized by the user. When the sound that the user wants to collect is highly likely to be included in the acoustic signal, it is possible to reduce the possibility that the acoustic signal is degraded. It is also possible to reduce the possibility that the processing for reducing the drive sound component of the acoustic signal is performed more than necessary and that thus the acoustic signal is degraded.

Alternatively, in the image sensing device configured as described above, an acoustic processing portion that processes the acoustic signal is further included, and, when the image sensing environment determination portion determines that a specific subject is present within an image indicated by an image signal, the operation determination portion makes a determination such that the acoustic processing portion reduces the drive sound component from the acoustic signal with a processing method corresponding to sound produced by the specific subject.

With the configuration described above, it is possible to effectively reduce the possibility that the component of sound that the user wants to collect in the acoustic signal is degraded.

Alternatively, in the image sensing device configured as described above, as the image sensing environment determination portion determines that a signal level of the acoustic signal is low and/or that a frequency characteristic of the acoustic signal is dissimilar to a frequency characteristic of the drive sound, the operation determination portion makes a determination such that the drive speed of the optical portion is decreased.

With the configuration described above, it is possible to reduce the possibility that the drive speed of the optical portion is limited such that the drive speed is needlessly reduced and that the operability and the convenience of the image sensing device are degraded.

Alternatively, in the image sensing device configured as described above, the operation determination portion determines the drive speed of the optical portion such that the frequency characteristic of the drive sound is similar to the frequency characteristic of the acoustic signal.

With the configuration described above, whatever state the acoustic sound is in, it is possible to reduce the possibility that the drive sound component of the acoustic signal is easily recognized by the user.

Alternatively, in the image sensing device configured as described above, as the image sensing environment determination portion determines that a signal level of the acoustic signal is low and/or that a frequency characteristic of the acoustic signal is dissimilar to a frequency characteristic of the drive sound, the operation determination portion makes a determination such that the drive speed of the optical portion is increased and a time period during which the drive sound is produced is reduced.

With the configuration described above, it is possible to reduce the possibility that the limitation is performed such that the drive speed of the optical portion is reduced and that thus, the operability and the convenience of the image sensing device are reduced.

Alternatively, in the image sensing device configured as described above, as the image sensing environment determination portion determines that movement in an image indicated by the image signal is small, the operation determination portion determines that the drive speed of the optical portion is reduced.

With the configuration described above, when it is not always necessary to rapidly drive the optical portion, it is possible to reduce the possibility that the drive sound component of the acoustic signal is easily recognized by the user. When it is highly necessary to rapidly drive the optical portion, it is also possible to reduce the possibility that the operability and the convenience of the image sensing device are significantly degraded.

Alternatively, in the image sensing device configured as described above, an image processing portion that acquires at least part of the image signal to produce a new image signal is further included, and the operation determination portion determines the drive speed of the optical portion and the magnitude of the part acquired by the image processing portion from the image signal such that the angle of view of the image indicated by the new image signal produced by the image processing portion is changed at a predetermined speed.

With the configuration described above, it is possible to effectively reduce the possibility that the operability and the convenience of the image sensing device are degraded.

Alternatively, in the image sensing device configured as described above, as the image sensing environment determination portion determines at least one of a large movement in the image indicated by the image signal and the darkness of the image indicated by the image signal, the drive speed of the optical portion is increased and the variation of the part acquired by the image processing portion from the image signal is reduced.

With the configuration described above, it is possible to reduce the degradation of the image.

With the configuration of the present invention described above, the effects of the drive sound are reduced according to the image sensing environment. Hence, it is possible to adaptively reduce the effects of the drive sound. For example, it is possible to adaptively reduce the effects of the drive sound on the acoustic signal and the effects of the drive sound on the operability and the convenience of the image sensing device.

The meanings and the effects of the present invention will be further apparent from the description of the embodiment below. However, the following embodiment is simply one of the embodiments of the present invention; the meanings of the present invention and terms of individual constituent components are not limited to the embodiment described below.

### BRIEF DESCRIPTION OF THE DRAWINGS

FIG. 1 is a block diagram showing an example of the overall configuration of an image sensing device that is an embodiment of the present invention;

FIG. 2 is a block diagram showing an example of the configuration of an image sensing portion, an optical portion and a sensor portion;

FIG. 3 is a block diagram showing an example of the configuration of a drive sound handling operation control portion;

FIG. 4 is a graph showing an example of the frequency characteristics of environment sound and drive sound;

FIG. 5 is a graph showing an example of the frequency characteristics of the environment sound and the drive sound;

FIG. 6 is a block diagram showing an example of a configuration or a function in which a drive sound handling operation of a second specific example (2) is performed;

FIG. 7 is a graph showing an example of the frequency characteristic of an acoustic signal at the time of execution of AF;

FIG. 8 is a block diagram showing an example of a configuration or a function in which a drive sound handling operation of a second specific example (3) is performed;

FIG. 9 is a graph showing a filter characteristic of filter processing that can be selected by a drive sound reduction filter of FIG. 8;

FIG. 10 is a diagram showing an example of a drive sound handling operation of a third specific example (1);

FIG. 11 is a diagram showing another example of the drive sound handling operation of the third specific example (1);

FIG. 12 is a diagram showing an example of a drive sound handling operation of a third specific example (2); and

FIG. 13 is a diagram showing another example of the drive sound handling operation of the third specific example (2).

### DETAILED DESCRIPTION OF PREFERRED EMBODIMENTS

An embodiment of the present invention will be described below with reference to accompanying drawings. An image sensing device that is an embodiment of the present invention will first be described. The image sensing device, which will be described below, is a digital video camera or the like that can produce, record and reproduce image (including a moving image and a still image; the same is true in the following description) signals and acoustic signals

<<Image Sensing Device>>

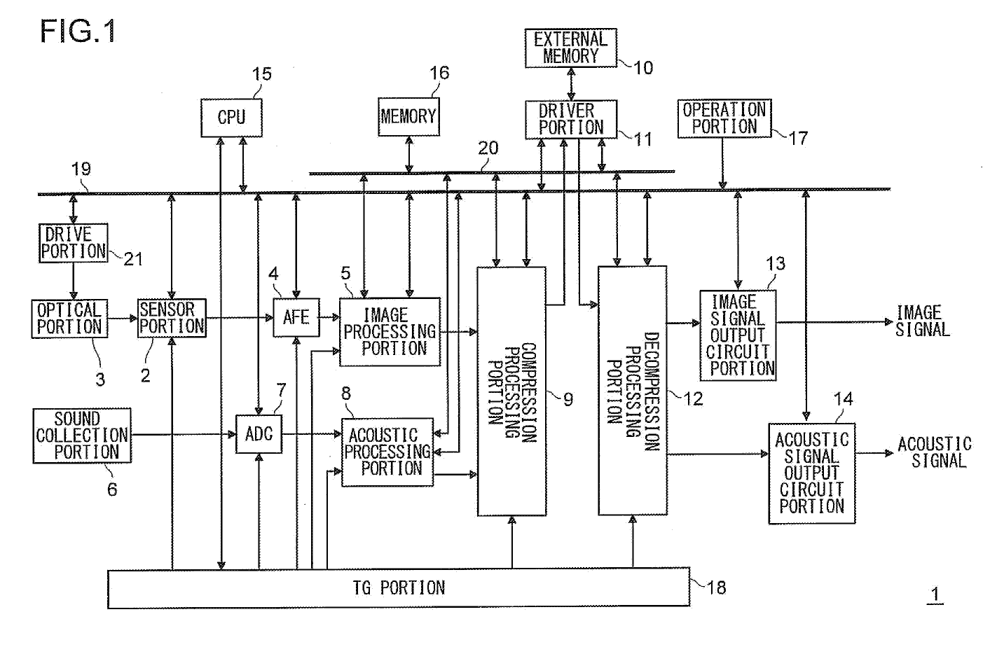

An example of the overall configuration of the image sensing device that is the embodiment of the present invention will first be described with reference to FIG. 1. FIG. 1 is a block diagram showing the example of the overall configuration of the image sensing device that is the embodiment of the present invention.

As shown in FIG. 1, the image sensing device 1 is formed with a solid-state image sensing element such as a CCD (charge coupled device) or a CMOS (complementary metal oxide semiconductor) sensor, and the image sensing device 1 includes: a sensor portion 2 that converts an optical image formed on a detection surface into an image signal which is an electrical signal and that acquires the image signal; an optical portion 3 that forms the optical image on the detection surface of the sensor portion 2.

The image sensing device 1 also includes: an AFE (analog front end) 4 that converts an analog image signal output from the sensor portion 2 into a digital signal and that adjusts a gain; an image processing portion 5 that performs various types of processing such as gradation correction processing on the image signal output from the AFE 4; a sound collection portion 6 that acquires, by collecting sound, an acoustic signal which is an electrical signal; an ADC (analog to digital converter) 7 that converts an analog acoustic signal output from the sound collection portion 6 into a digital signal; an acoustic processing portion 8 that performs various types of processing such as noise removal on the acoustic signal output from the ADC 7 and that outputs it; a compression processing portion 9 that performs compression encoding processing such as MPEG (moving picture experts group) compression mode on the image signal output from the image processing portion 5 and the the acoustic signal output from the acoustic processing portion 8; an external memory 10 that records a compression encoding signal which has been compressed and encoded by the compression processing portion 9; a driver portion 11 that records and reads the compression encoding signal in and from the external memory 10; and a decompression processing portion 12 that decompresses and decodes the compression encoding signal which is read by the driver portion 11 from the external memory 10.

The image sensing device 1 also includes: an image signal output circuit portion 13 that converts the image signal resulting from the decoding by the decompression processing portion 12 into a signal which can be displayed on a display portion (not shown) such as a monitor; and an acoustic signal output circuit portion 14 that converts the acoustic signal resulting from the decoding by the decompression processing portion 12 into a signal which can be reproduced in an acoustic reproduction portion (not shown) such as a speaker.

The image sensing device 1 also includes: a CPU (central processing unit) 15 that controls the overall operation within the image sensing device 1; a memory 16 that stores programs for performing individual types of processing and that temporarily stores data while the program is being executed; an operation portion 17 that is composed of a button for starting the sensing of an image, a button for adjusting, for example, image sensing conditions and the like and that receives an instruction from the user; a timing generator (TG) portion 18 that outputs a timing control signal for synchronizing the operation timing of each portion; a bus 19 through which data is exchanged between the CPU 15 and each block; and a bus 20 through which data is exchanged between the memory 16 and each block. For ease of description, in the following description, the buses 19 and 20 are omitted in exchange between the individual blocks.

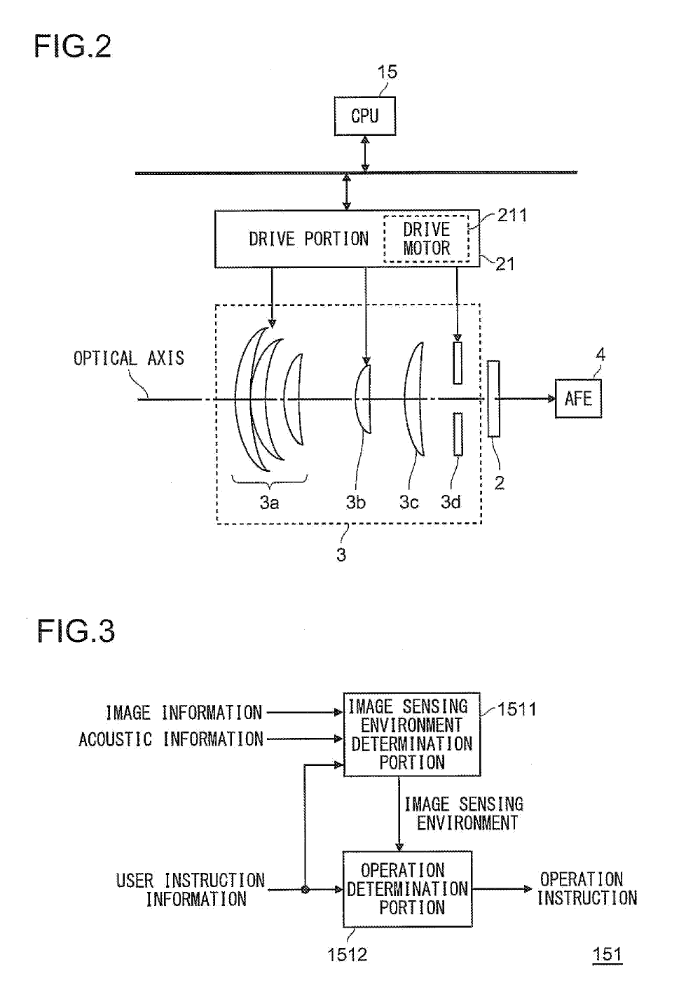

The image sensing device 1 also includes a drive portion 21 that drives the optical portion 3. An example of the configuration of the drive portion 21, the optical portion 3 and the sensor portion 2 will be described with reference to the drawing. FIG. 2 is a block diagram showing the example of the configuration of the image sensing device, the optical portion and the sensor portion.

As shown in FIG. 2, the optical portion 3 includes: various types of lenses such as a focus lens 3a, a zoom lens 3b and a supplementary lens 3c; and an aperture 3d that adjusts the amount of light (exposure) of the optical image formed on the detection surface of the sensor portion 2. The drive portion 21 includes a drive motor 211 that generates power for driving the optical portion 3.

Although the image sensing device 1 that can generate image signals for a moving image and a still image has been described as one example, the image sensing device 1 may generate only an image signal for a moving image. The display portion and the acoustic reproduction portion described above may be formed integrally with the image sensing device 1 or may be separated therefrom and connected thereto with a terminal, a cable and the like provided in the image sensing device 1.

Any type of component may be used as the external memory 10 as long as the external memory 10 can record an image signal and an acoustic signal. For example, a semiconductor memory such as an SD (secure digital) card, an optical disc such as a DVD, a magnetic disk such as a hard disk or the like can be used as the external memory 10. The external memory 10 may be removable from the image sensing device 1.

An example of the overall operation when the image sensing device 1 generates an image signal for a moving image will now be descried with reference to FIGS. 1 and 2.

The optical portion 3 first forms the optical image on the detection surface of the sensor portion 2. Here, the drive portion 21 drives the optical portion 3, and thus the optical image in any state is formed. Then, the sensor portion 2 photoelectrically converts, through the optical portion 3, the optical image formed on the detection surface, and thereby acquires the image signal. Furthermore, the sensor portion 2 outputs, with predetermined timing, the image signal to the AFE 4 in synchronization with the timing control signal input from the TG portion 18.

Here, the drive portion 21 is operated, for example, through control by the CPU 15 to drive the optical portion 3. Specifically, for example, the focus lens 3a is moved along an optical axis to achieve focus, and the zoom lens 3b is moved along the optical axis to perform zoom. The opening of the aperture 3d is controlled, and thus exposure is controlled.

The AFE 4 converts the image signal acquired by the optical portion 3 from analog to digital, and inputs it to the image processing portion 5. The image processing portion 5 converts the input image signal having R (red), G (green) and B (blue) components into an image signal having components of a brightness signal (Y) and a color difference signal (U, V), and performs various types of processing such as gradation correction and edge enhancement. The memory 16 operates as a frame memory, and temporarily holds the image signal when the image processing portion 5 performs processing.

Here, the drive portion 21 can be controlled to drive the optical portion 3 according to the image signal input to the image processing portion 5. In this way, for example, autofocusing (hereinafter referred to as AF) in which the focus lens 3a is driven in such a direction that focus is achieved according to the result of processing which is performed by the image processing portion 5 on the image signal and autoexposure in which the opening of the aperture 3d is adjusted such that an appropriate amount of exposure is acquired are performed. The drive portion 21 can also be controlled to drive the optical portion 3 according to an instruction input through the operation portion 17 by the user.

The sound collection portion 6 converts sound into an electrical signal and thereby acquires an acoustic signal. The ADC 7 converts the acoustic signal acquired by the sound collection portion 6 from analog to digital, and inputs it to the acoustic processing portion 8. The acoustic processing portion 8 performs various types of processing such as noise removal and forceful control on the input acoustic signal.

Then, both the image signal output from the image processing portion 5 and the acoustic signal output form the acoustic processing portion 8 are input to the compression processing portion 9, and are compressed in the compression processing portion 9 with a predetermined compression mode. Here, the image signal and the acoustic signal are associated with each other in terms of time such that the image and the sound are synchronized at the time of reproduction. Then, the compression encoding signal output from the compression processing portion 9 is recorded in the external memory 10 through the driver portion 11.

The compression encoding signal for a moving image recorded in the external memory 10 is read by the decompression processing portion 12 based on an instruction from the user. The decompression processing portion 12 decompresses and decodes the compression encoding signal, and thereby generates and outputs an image signal and an acoustic signal Then, the image signal output circuit portion 13 converts the image signal output from the decompression processing portion 12 into a form which can be displayed on the display portion, and outputs it; the acoustic signal output circuit portion 14 converts the acoustic signal output from the decompression processing portion 12 into a form which can be reproduced in the acoustic reproduction portion and outputs it.

When a so-called preview mode is used in which an image displayed on the display portion or the like is recognized by the user without the image signal being recorded, the image signal output from the image processing portion 5 may be output to the image signal output circuit portion 13 without being compressed and encoded. When the image signal is recorded, at the same time when the image signal is compressed and encoded by the compression processing portion 9 and is recorded in the external memory 10, the image signal may be output to the display portion or the like through the image signal output circuit portion 13. The image signal output from the image processing portion 5 and the acoustic signal output from the acoustic processing portion 8 may be recorded in the external memory 10 without being compressed and encoded, that is, without being processed.

<<Drive Sound Handling Operation>>

The image sensing device 1 of this example performs an operation (hereinafter referred to as a drive sound handling operation) of reducing the effects of the drive sound produced when the optical portion 3 is driven. The drive sound handling operation will be specifically described below.

<Configuration of Drive Sound Handling Operation Control Portion>

An example of the configuration (hereinafter referred to as a drive sound handling operation control portion) that determines the details of the drive sound handling operation to be performed and provides an instruction will first be described with reference to the drawing. FIG. 3 is a block diagram showing the example of the configuration of the drive sound handling operation control portion. The drive sound handling operation control portion 151 shown in FIG. 3 may be interpreted as an independent configuration within the image sensing device 1 or may be interpreted as one part or one function of at least one portion (for example, the CPU 15) of the image sensing device 1 shown in FIG. 1.

As shown in FIG. 3, the drive sound handling operation control portion 151 includes: an image sensing environment determination portion 1511 that determines an environment (hereinafter referred to as an image sensing environment) when the image signal is acquired by the sensor portion 2 (hereinafter referred to as “at the time of image sensing”); and an operation determination portion 1512 that determines the details of the drive sound handling operation based on the image sensing environment determined by the image sensing environment determination portion 1511 and that outputs an operation instruction indicating the details of the operation.

The image sensing environment determination portion 1511 can acquire information (hereinafter referred to as image information) as to an image signal necessary for determination of the image sensing environment. The image information may be information that is obtained by the processing of the image signal by the image processing portion 5 or may be the image signal itself. For ease of description, in the following description, information that is obtained by he processing of the image signal by the image processing portion 5 is assumed to be the image information.

The image sensing environment determination portion 1511 can acquire information (hereinafter referred to as acoustic information) as to an acoustic signal necessary for determination of the image sensing environment. The acoustic information may be information that is obtained by the processing of the acoustic signal by the acoustic processing portion 8 or may be the acoustic signal itself. For ease of description, in the following description, information that is obtained by the processing of the acoustic signal by the acoustic processing portion 8 is assumed to be the acoustic information.

The image sensing environment determination portion 1511 can also acquire information (hereinafter referred to as user instruction information) indicating the details of an operation of the image sensing device 1 indicated by the user. The user instruction information is information that is input by the user through the operation portion 17, and can include a direct instruction to perform the operation of the image sensing device 1 (for example, an instruction to perform zoom) and an indirect instruction to perform the operation of the image sensing device 1 such as a method of sensing an image (for example, an instruction indicating whether the AF is utilized and an instruction indicating various image sensing modes such as an animal image sensing mode and a scenery image sensing mode).

The image sensing environment determined by the image sensing environment determination portion 1511 is various environments at the time of image sensing, such as a state of a subject whose image is to be sensed and an atmosphere (for example, brightness), a state of sound coming to the image sensing device 1 at the time of image sensing and the details of an operation that is performed by the image sensing device 1 at the time of image sensing. When a specific example of the drive sound handling operation is described later, specific examples of the image information, the acoustic information, the user instruction information and the image sensing environment will be described simultaneously.

The operation determination portion 1512 determines a drive sound handling operation that needs to be performed based on the image sensing environment determined by the image sensing environment determination portion 1511, and outputs an operation instruction. For example, the operation determination portion 1512 outputs the operation instruction such that an operation indicated by the input user instruction information is performed by the image sensing device 1 as an operation corresponding to the image sensing environment determined by the image sensing environment determination portion 1511. For example, the operation instruction can be input to the drive portion 21, the acoustic processing portion 8, the image processing portion 5 and the like.

The drive sound handling operation can include an operation of reducing the effects of the drive sound on the acoustic signal. This drive sound handling operation is performed by the determination of, for example, the drive speed of the optical portion 3 and the method of processing the acoustic signal by the operation determination portion 1512. For example, the effects of the drive sound on the acoustic signal are that the drive sound component of the acoustic signal is more likely to be recognized by the user and that processing for reducing the drive sound component of the acoustic signal causes the acoustic signal to be degraded.

The drive sound handling operation can include an operation of reducing the effects of the drive sound on the operability and the convenience of the image sensing device 1. This drive sound handling operation is performed by the determination of, for example, the drive speed of the optical portion 3 and the method of processing the image signal by the operation determination portion 1512. For example, the effects of the drive sound on the operability and the convenience of the image sensing device 1 are that the reduction of the drive speed of the optical portion 3 for decreasing the drive sound causes the operability and the convenience of the image sensing device 1 to be degraded.

In the configuration described above, the effects of the drive sound are reduced according to the image sensing environment. Thus, it is possible to adaptively reduce the effects of the drive sound. For example, it is possible to adaptively reduce the effects of the drive sound on the acoustic signal and the effects of the drive sound on the operability and the convenience of the image sensing device 1.

Although, in FIG. 3, the image information, the acoustic information and the user instruction information are input to the image sensing environment determination portion 1511, this configuration is only one example. Unnecessary piece of information among these pieces of information may fail to be input; any other necessary piece of information may be input.

<Specific Examples of the Drive Sound Handling Operation>

Specific examples of the drive sound handling operation will be described below with reference to accompanying drawing. It is possible to combine the specific examples of the drive sound handling operation described below and perform the combination unless a contradiction arises.

[First Specific Example]

A first specific example of the drive sound handling operation will first be described. The first specific example of the drive sound handling operation relates to the drive speed of the optical portion 3. The first specific example is divided into examples (1) to (5), and the examples (1) to (5) will be individually described below. It is possible to combine the examples (1) to (5) and perform the combination unless a contradiction arises.

First Specific Example: (1)

In the drive sound handling operation of this example, the drive speed of the optical portion 3 is adaptively limited, and thus the effects of the drive sound on the acoustic signal and the effects of the drive sound on the operability and the convenience of the image sensing device 1 are reduced.

Based on the input acoustic information, the image sensing environment determination portion 1511 checks the amplitude (signal level) of the acoustic signal. Specifically, for example, the image sensing environment determination portion 1511 checks the average value (the first average value) of the signal levels of the acoustic signals in a predetermined period of time (for example, one second). Here, for example, the acoustic processing portion 8 outputs, as the acoustic information, the calculated first average value (or the signal levels of the acoustic signals). Then, the image sensing environment determination portion 1511 checks whether or not the first average value is greater than a preset threshold value (first threshold value).

If the image sensing environment determination portion 1511 recognizes that the first average value is greater than the first threshold value, the image sensing environment is determined to be an image sensing environment in which it is unnecessary to limit the drive speed of the optical portion 3. This is because the drive sound is easily embedded in sound (hereinafter referred to as environment sound), other than the drive sound, that comes from the surrounding of the image sensing device 1 and that is collected, and it is difficult for the user to recognize the drive sound component of the acoustic signal.

In this case, even if, for example, the user instruction information indicating that zoom is to be performed is input, the operation determination portion 1512 outputs, to the drive portion 21, an operation instruction to fail to particularly place limitation on the drive speed of the optical portion 3.

On the other hand, if the image sensing environment determination portion 1511 recognizes that the first average value is equal to or less than the first threshold value, the mage sensing environment is determined to be an image sensing environment in which it is necessary to limit the drive speed of the optical portion 3. This is because the drive sound is unlikely to be embedded in the environment sound, and it is easy for the user to recognize the drive sound component of the acoustic signal.

In this case, if, for example, the user instruction info' nation indicating that zoom is to be performed is input, the operation determination portion 1512 outputs, to the drive portion 21, an operation instruction to place limitation such that the drive speed of the optical portion 3 is equal to or less than a predetermined speed (for example, the drive speed of the optical portion 3 is reduced to half the speed when the operation instruction to fail to particularly place limitation is output).

With the configuration described above, it is possible to reduce the possibility that the drive sound component of the acoustic signal is easily recognized by the user. It is also possible to reduce the possibility that the drive speed of the optical portion 3 is limited such that the drive speed is needlessly reduced and that the operability and the convenience of the image sensing device 1 are degraded.

First Specific Example: (2)

In the drive sound handling operation of this example, the drive speed of the optical portion 3 is adaptively limited, and thus the effects of the drive sound on the acoustic signal and the effects of the drive sound on the operability and the convenience of the image sensing device 1 are reduced.

Based on the input acoustic information, the image sensing environment determination portion 1511 checks the frequency characteristic of the acoustic signal. Here, for example, the acoustic processing portion 8 performs FFT (fast Fourier transform) processing or the like to calculate the frequency characteristic of the acoustic signal, and outputs it as the acoustic information.

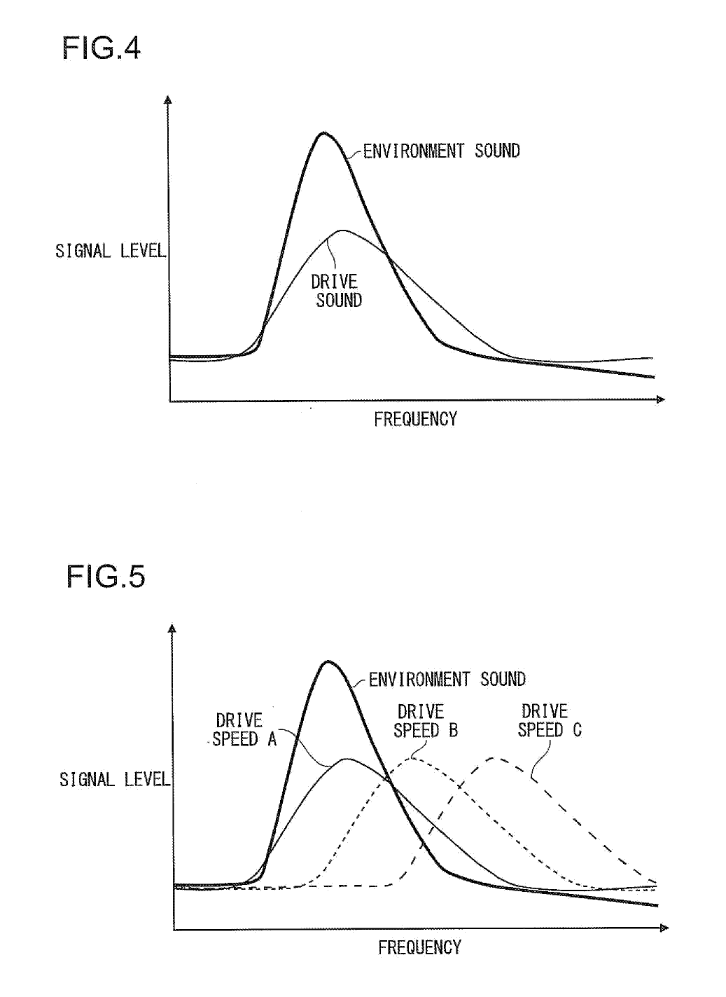

Based on the comparison of known (for example, prerecorded) frequency characteristic of the drive sound and the frequency characteristic of the environment sound, the image sensing environment determination portion 1511 determines whether or not the image sensing environment is an image sensing environment in which it is necessary to limit the drive speed of the optical portion 3. The determination method will be described with reference to the drawing. FIG. 4 is a graph showing an example of the frequency characteristic of the environment sound and the drive sound.

For example, as shown in FIG. 4, if a main frequency (for example, the frequency whose signal level peaks; either one or a plurality of frequencies may be used) of the drive sound is substantially equal to a main frequency of the environment sound, the image sensing environment determination portion 1511 recognizes that the drive sound is similar to the environment sound. By contrast, if the main frequency of the drive sound is not substantially equal to the main frequency of the environment sound, the image sensing environment determination portion 1511 recognizes that the drive sound is not similar to the environment sound.

If the image sensing environment determination portion 1511 recognizes that the drive sound is similar to the environment sound, the image sensing environment is determined not to be an image sensing environment in which it is necessary to limit the drive speed of the optical portion 3. This is because the drive sound is easily embedded in the environment sound, and it is difficult for the user to recognize the drive sound component of the acoustic signal.

In this case, even if, for example, the user instruction information indicating that zoom is to be performed is input, the operation determination portion 1512 outputs, to the drive portion 21, an operation instruction to fail to particularly place limitation on the drive speed of the optical portion 3.

On the other hand, if the image sensing environment determination portion 1511 recognizes that the drive sound is not similar to the environment sound, the image sensing environment is determined to be an image sensing environment in which it is necessary to limit the drive speed of the optical portion 3. This is because the drive sound is unlikely to be embedded in the environment sound, and it is easy for the user to recognize the drive sound component of the acoustic signal.

In this case, if, for example, the user instruction information indicating that zoom is to be performed is input, the operation determination portion 1512 outputs, to the drive portion 21, an operation instruction to place limitation such that the drive speed of the optical portion 3 is equal to or less than a predetermined speed (for example, the drive speed of the optical portion 3 is reduced to half the speed when the operation instruction to fail to particularly place limitation is output).

With the configuration described above, it is possible to reduce the possibility that the drive sound component of the acoustic signal is easily recognized by the user. It is also possible to reduce the possibility that the drive speed of the optical portion 3 is limited such that the drive speed is needlessly reduced and that the operability and the convenience of the image sensing device 1 are degraded.

When this example is applied to the image sensing device 1 in which the frequency characteristic of the drive sound is unlikely to vary according to the drive speed of the optical portion 3 (the amount of variation is small), it is possible to effectively reduce the possibility that the drive sound component of the acoustic signal is easily recognized by the user. Therefore, the application described above is preferable.

First Specific Example: (3)

In the drive sound handling operation of this example, the drive speed of the optical portion 3 is adaptively limited, and thus the effects of the drive sound on the acoustic signal are reduced.

Based on the input acoustic information, the image sensing environment determination portion 1511 checks the frequency characteristic of the acoustic signal. Here, for example, the acoustic processing portion 8 performs FFT processing or the like to calculate the frequency characteristic of the acoustic signal, and outputs it as the acoustic information.

Based on known (for example, prerecorded) frequency characteristic of the individual drive sounds corresponding to the individual drive speeds of the optical portion 3 and the frequency characteristic of the environment sound, the image sensing environment determination portion 1511 determines which one of the drive speeds of the optical portion 3 that can be selected by the drive portion 21 is an appropriate image sensing environment. The determination method will be described with reference to the drawing. FIG. 5 is a graph showing an example of the frequency characteristic of the environment sound and the drive sound.

For example, as shown in FIG. 5, the image sensing environment determination portion 1511 detects a drive speed that produces a drive sound whose main frequency is substantially equal to (is most similar to) a main frequency (for example, the frequency whose signal level peaks; either one or a plurality of frequencies may be used) of the environment sound among the drive speeds of the optical portion 3 that can be selected by the drive portion 21. Then, the image sensing environment determination portion 1511 determines that the image sensing environment is determined to be an image sensing environment suitable for the detected drive speed of the optical portion 3. In the example shown in FIG. 5, the image sensing environment is determined to be an image sensing environment suitable for a drive speed A.

In the example shown in FIG. 5, when the optical portion 3 is driven at the drive speed A, the drive sound is similar to the environment sound, and thus the drive sound is easily embedded in the environment sound. Hence, the drive sound component of the acoustic signal is unlikely to be recognized by the user.

In this case, if, for example, the user instruction information indicating that zoom is to be performed is input, the operation determination portion 1512 outputs, to the drive portion 21, an operation instruction to drive the optical portion 3 at the drive speed A.

With the configuration described above, whatever state the acoustic sound is in, it is possible to reduce the possibility that the drive sound component of the acoustic signal is easily recognized by the user.

When this example is applied to the image sensing device 1 in which the frequency characteristic of the drive sound is easily vary according to the drive speed of the optical portion 3 (the amount of variation is large), it is possible to effectively reduce the possibility that the drive sound component of the acoustic signal is easily recognized by the user. Therefore, the application described above is preferable.

With respect to the drive speeds A to C of the optical portion 3 shown in FIG. 5, the drive speed A may be the lowest, and the drive speed C may be the fastest. Although, in FIG. 5, for ease of illustration, signal levels are assumed not to vary on the frequency characteristic of the individual drive sounds at the drive speeds A to C of the optical portion 3, the signal levels may vary. For example, as the drive speed of the optical portion 3 is increased, the signal level may be increased.

First Specific Example: (4)

In the drive sound handling operation of this example, the drive speed of the optical portion 3 is adaptively limited, and thus the effects of the drive sound on the operability and the convenience of the image sensing device 1 are reduced.

Based on the input image information, the image sensing environment determination portion 1511 checks the magnitude of movement in an image (hereinafter referred simply to as an image) indicated by the image signal. Specifically, for example, the image sensing environment determination portion 1511 checks the average value (the second average value) of the amount of change of the image in a predetermined period of time (for example, one second). Here, for example, the image processing portion 5 outputs, as the image information, a value of the amount of change of the image and the calculated second average value. The image processing portion 5 may calculate a movement vector as the amount of change of the image. The movement vector may be calculated using any known method such as a block matching method or a representative point matching method. Then, the image sensing environment determination portion 1511 checks whether or not the second average value is greater than a preset threshold value (the second threshold value).

If the image sensing environment determination portion 1511 recognizes that the second average value is greater than the second threshold value, the image sensing environment is determined to be an image sensing environment in which it is unnecessary to limit the drive speed of the optical portion 3. This is because if the movement in the image is large, it is highly necessary to rapidly drive the optical portion 3 such by zoom, and if the drive sound is reduced such that the drive speed of the optical portion 3 is decreased, the operability and the convenience of the image sensing device 1 are highly likely to be significantly degraded.

In this case, even if, for example, the user instruction information indicating that zoom is to be performed is input, the operation determination portion 1512 outputs, to the drive portion 21, an operation instruction to fail to particularly place limitation on the drive speed of the optical portion 3.

On the other hand, if the image sensing environment determination portion 1511 recognizes that the second average value is equal to or less than the second threshold value, the image sensing environment is determined to be an image sensing environment in which it is necessary to limit the drive speed of the optical portion 3. This is because if the movement in the image is small, it is not always necessary to rapidly drive the optical portion 3 such by zoom, and even if the drive sound is reduced such that the drive speed of the optical portion 3 is decreased, the operability and the convenience of the image sensing device 1 are unlikely to be significantly degraded.

In this case, if, for example, the user instruction information indicating that zoom is to be performed is input, the operation determination portion 1512 outputs, to the drive portion 21, an operation instruction to place limitation such that the drive speed of the optical portion 3 is equal to or less than a predetermined speed (for example, the drive speed of the optical portion 3 is reduced to half the speed when the operation instruction to fail to particularly place limitation is output).

With the configuration described above, when it is not always necessary to rapidly drive the optical portion 3, it is possible to reduce the possibility that the drive sound component of the acoustic signal is easily recognized by the user. When it is highly necessary to rapidly drive the optical portion 3, it is also possible to reduce the possibility that the operability and the convenience of the image sensing device 1 are significantly degraded.

The image sensing environment determination portion 1511 may determine the image sensing environment based on the user instruction information in addition to (or instead of) the image information. In this case, the image sensing environment determination portion 1511 may determine, by the input of, for example, the user instruction information (animal image sensing mode) indicating that the image of an animal is sensed, that the image sensing environment is determined to be an image sensing environment in which it is unnecessary to limit the drive speed of the optical portion 3. Moreover, the image sensing environment determination portion 1511 may determine, by the input of, for example, the user instruction information (scenery sensing mode) indicating that the image of scenery is sensed, that the image sensing environment is determined to be an image sensing environment in which it is necessary to limit the drive speed of the optical portion 3.

First Specific Example: (5)

The drive sound handling operation of this example is variations of the first specific examples (1), (2) and (4) described above. Specifically, in each of the above examples of this example, if the image sensing environment determination portion 1511 determines that the image sensing environment is an image sensing environment in which it is necessary to limit the drive speed of the optical portion 3, the operation determination portion 1512 outputs, to the drive portion 21, an operation instruction to place limitation such that the drive speed of the optical portion 3 is equal or greater than a predetermined speed (for example, the maximum). Although, in this case, a large drive sound can be produced, it is possible to reduce a time period during which the drive sound is produced.

With the configuration described above, it is possible to reduce the possibility that the drive sound component of the acoustic signal is easily recognized by the user. It is also possible to reduce the possibility that the limitation is performed such that the drive speed of the optical portion 3 is reduced and that thus, the operability and the convenience of the image sensing device 1 are reduced.

A large drive sound component of the acoustic sound signal produced by the drive sound handling operation of this example may be reduced by a method of each example of a second specific example, which will be described later.

[Second Specific Example]

A second specific example of the drive sound handling operation will now be described. The second specific example of the drive sound handling operation relates to a method of processing the acoustic signal by the acoustic processing portion 8. The second specific example is divided into examples (1) to (3), and the examples (1) to (3) will be individually described below. It is possible to combine the examples (1) to (3) and perform the combination unless a contradiction arises.

Second Specific Example: (1)

In the drive sound handling operation of this example, the processing on the acoustic signal is adaptively performed, and thus the effects of the drive sound on the acoustic signal are reduced.

Based on the input acoustic information, the image sensing environment determination portion 1511 checks the signal level of the acoustic signal. Specifically, for example, the image sensing environment determination portion 1511 checks the average value (the third average value) of the signal levels of the acoustic signals in a predetermined period of time (for example, one second). Here, for example, the acoustic processing portion 8 outputs, as the acoustic information, the signal level of the acoustic signal and the calculated third average value. Then, the image sensing environment determination portion 1511 checks whether or not the third average value is greater than a preset threshold value (third threshold value).

If the image sensing environment determination portion 1511 recognizes that the third average value is greater than the third threshold value, the image sensing environment is determined not to be an image sensing environment in which it is necessary to perform processing for reducing the drive sound component of the acoustic signal. This is because it is highly likely that sound which the user wants to collect is included in the acoustic signal and the processing is highly likely to disadvantageously cause the degradation of the acoustic signal.

In this case, even if, for example, the user instruction information indicating that zoom is to be performed is input, the operation determination portion 1512 outputs, to the acoustic processing portion 8, an operation instruction to fail to perform processing for reducing the drive sound component of the acoustic signal.

On the other hand, if the image sensing environment determination portion 1511 recognizes that the third average value is equal to or less than the third threshold value, the image sensing environment is determined to be an image sensing environment in which it is necessary to perform processing for reducing the drive sound component of the acoustic signal. This is because it is unlikely that sound which the user wants to collect is included in the acoustic signal and the processing is unlikely to disadvantageously cause the degradation of the acoustic signal.

In this case, if, for example, the user instruction information indicating that zoom is to be performed is input, the operation determination portion 1512 outputs, to the acoustic processing portion 8, an operation instruction to perform the processing for reducing the drive sound component of the acoustic signal.

For example, as the processing for reducing the drive sound component of the acoustic signal, processing for reducing the signal level of the acoustic signal down to about the silent level (0) can be employed. For example, processing for replacing the target acoustic signal with an acoustic signal that is collected and recorded when the drive sound is not produced (for example, when the CPU 15 and the operation determination portion 1512 do not output, to the drive portion 21, an operation instruction to drive the optical portion 3) can be employed.

With the configuration described above, when the sound that the user wants to collect is unlikely to be included in the acoustic signal, it is possible to reduce the possibility that the drive sound component of the acoustic signal is easily recognized by the user. When the sound that the user wants to collect is highly likely to be included in the acoustic signal, it is possible to reduce the possibility that the acoustic signal is degraded.

When, as the processing for reducing the drive sound component of the acoustic signal, the processing for replacing the target acoustic signal with the acoustic signal that is collected and recorded when the drive sound is not produced is employed, the recorded acoustic signal may be divided by a predetermined time period, and the divided acoustic signals may be randomly arranged and replaced. With this configuration, it is possible to reduce the possibility that the repetition of the similar acoustic singles causes the acoustic signal after the replacement to become unnatural.

Second Specific Example: (2)

In the drive sound handling operation of this example, the method of processing the acoustic signal is adaptively controlled, and thus the effects of the drive sound on the acoustic signal are reduced.

Based on the input acoustic information, the image sensing environment determination portion 1511 checks the signal level of the acoustic signal. Specifically, for example, the image sensing environment determination portion 1511 checks the average value (the fourth average value) of the signal levels of the acoustic signals in a predetermined period of time (for example, one second). Here, for example, the acoustic processing portion 8 outputs, as the acoustic information, the signal level of the acoustic signal and the calculated fourth average value. Then, based on the input image information, the image sensing environment determination portion 1511 checks whether or not a specific subject is present in the image. Here, for example, the image processing portion 5 outputs, as the image information, the result of the detection of whether or not the specific subject is present in the image.

Based on whether or not the fourth average value is greater than a preset threshold value (fourth threshold value) and whether or not the specific subject is present in the image, the image sensing environment determination portion 1511 determines which one of the types of processing on the acoustic signal that can be performed by the acoustic processing portion 8 is an appropriate image sensing environment. In the following description, in order for specific description to be given, the specific subject is assumed to be a person.

If the image sensing environment determination portion 1511 recognizes that the fourth average value is greater than the fourth threshold value and a person is present in the image, special processing for reducing the drive sound component of the acoustic signal and the degradation of sound produced by a person is determined to be an appropriate image sensing environment. This is because it is highly likely that sound which the user wants to collect is the sound produced by a person and the sound is highly likely to be included in the acoustic signal.

In this case, if, for example, the user instruction information indicating that zoom is to be performed is input, the operation determination portion 1512 outputs, to the acoustic processing portion 8, an operation instruction to perform special processing for reducing the drive sound component of the acoustic signal and the degradation of the sound produced by a person.

If the image sensing environment determination portion 1511 recognizes that the fourth average value is greater than the fourth threshold value and no person is present in the image, processing that is not specifically (for example, generally) designed for reducing the drive sound component of the acoustic signal and the degradation of sound produced by a person is determined to be an appropriate image sensing environment. This is because it is highly likely that sound which the user wants to collect is included in the acoustic signal but it is unlikely that the sound is produced by a person.

In this case, if, for example, the user instruction information indicating that zoom is to be performed is input, the operation determination portion 1512 outputs, to the acoustic processing portion 8, an operation instruction to perform the processing that is not specifically designed for reducing the drive sound component of the acoustic signal and the degradation of sound produced by a person.

For example, as the special processing for reducing the drive sound component of the acoustic signal and the degradation of sound produced by a person, a joint map method can be employed. Moreover, for example, as the processing that is not specifically designed for reducing the drive sound component of the acoustic signal and the degradation of sound produced by a person, a spectrum suppression method can be employed.

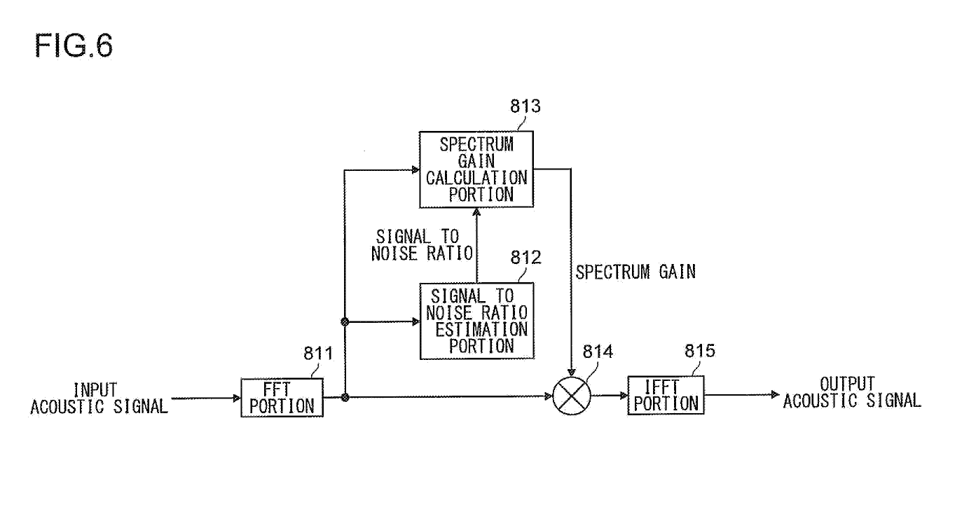

The joint map method and the spectrum suppression method will be described with reference to the drawing. FIG. 6 is a block diagram showing an example of a configuration or a function in which the drive sound handling operation of the second specific example (2) is performed. Each block shown in FIG. 6 can be interpreted as part of the configuration or one function of the acoustic processing portion 8.

As shown in FIG. 6, the drive sound handling operation of this example is performed by: an FFT portion 811 that performs the FFT processing on the acoustic signal (input acoustic signal) to be processed and that outputs it as the acoustic signal of a frequency axis; a signal to noise ratio estimation portion 812 that estimates a signal to noise ratio 812 of the acoustic signal output from the FFT portion 811; a spectrum gain calculation portion 813 that calculates a spectrum gain based on the acoustic signal output from the FFT portion 811 and the signal to noise ratio estimated by the signal to noise ratio estimation portion 812; a multiplication portion 814 that multiplies the acoustic signal output from the FFT portion 811 by the spectrum gain calculated by the spectrum gain calculation portion 813; an IFFT portion 815 that performs IFFT (inverse fast Fourier transform) processing on the acoustic signal obtained by the multiplication portion 814 and that thus outputs it as the acoustic signal (output acoustic signal) of a time axis; and the drive sound handling operation control portion 151 described above.

The signal to noise ratio estimation portion 812 estimates a noise (especially drive sound) component included in the input acoustic signal that has been converted by the FFT portion 811 to the frequency axis as the signal to noise ratio of each frequency. When the processing of the joint map method is performed, for example, the signal to noise ratio estimation portion 812 assumes that the statistical model of noise is Gaussian distribution and that the statistical model of environment sound is super Gaussian distribution (distribution in which the characteristic of sound produced by a person is accurately expressed). On the other hand, when the processing of the spectrum suppression method is performed, for example, the signal to noise ratio estimation portion 812 assumes that each of the statistical models of noise and environment sound is Gaussian distribution.

The spectrum gain calculation portion 813 calculates the spectrum gain that is the gain of each frequency for reducing the noise component included in the acoustic signal. Then, the multiplication portion 814 performs, for each frequency of the acoustic signal, multiplication on the spectrum gain calculated by the spectrum gain calculation portion 813. Furthermore, the IFFT portion 815 converts the acoustic signal of the frequency axis obtained by the multiplication portion 814 into the acoustic signal of the time axis, and thus the output acoustic signal in which noise is reduced is obtained.

If the image sensing environment determination portion 1511 recognizes that the fourth average value is equal to or less than the fourth threshold value, processing for significantly reducing the drive sound component of the acoustic signal is determined to be an appropriate image sensing environment. This is because it is unlikely that sound which the user wants to collect is included in the acoustic signal and it is unlikely that the processing disadvantageously causes the degradation of the acoustic signal.

In this case, if, for example, the user instruction information indicating that zoom is to be performed is input, the operation determination portion 1512 outputs, to the acoustic processing portion 8, an operation instruction to perform the processing for significantly reducing the drive sound component of the acoustic signal.

As the processing for significantly reducing the drive sound component of the acoustic signal, the processing described in the second specific example (1) of the drive sound handling operation can be employed. For example, the processing for reducing the signal level of the acoustic signal down to about the silent level and the processing for replacing the target acoustic signal with the acoustic signal that is collected and recorded when the drive sound is not included can be employed.

With the configuration described above, it is possible to reduce the possibility that the drive sound component of the acoustic signal is easily recognized by the user. Furthermore, it is possible to effectively reduce the possibility that the component of sound that the user wants to collect in the acoustic signal is degraded.

When the person who is the specific subject is detected from the image, face detection processing may be employed. When the face detection processing is employed, various known types of technology may be employed. For example, Adaboost (Yoav Freund, Robert E. Schapire, “A decision-theoretic generalization of on-line learning and an application to boosting”, European Conference on Computational Learning Theory, Sep. 20, 1995) may be employed. This method is a method of detecting a face by sequentially identifying individual portions of a frame of a moving image with a plurality of weak classifiers weighed by identifying a large number of teacher samples (facial or non-facial sample images). With this method, any person may be detected or a specific person may be detected.

The image sensing environment determination portion 1511 may determine the image sensing environment based on the user instruction information in addition to (or instead of) the acoustic information and the image information. In this case, the image sensing environment determination portion 1511 may determine, by the input of, for example, the user instruction information (person image sensing mode) indicating that the image of a person is sensed, that the special processing for reducing the drive sound component of the acoustic signal and the degradation of sound produced by a person is an appropriate image sensing environment. Moreover, the image sensing environment determination portion 1511 may determine, by the input of the user instruction information (an image sensing mode other than the person image sensing mode) indicating that the image of anything other than a person is sensed, that the processing that is not specifically designed for reducing the drive sound component of the acoustic signal and the degradation of sound produced by a person is an appropriate image sensing environment.

Second Specific Example: (3)

In the drive sound handling operation of this example, the method of processing the acoustic signal is adaptively controlled, and thus the effects of the drive sound on the acoustic signal are reduced. In this example, in order for specific description to be given, a case where the effects of the drive sound (hereinafter referred to as AF drive sound) produced by driving the optical portion 3 at the time of execution of the AF on the acoustic signal are reduced will be described as an example.

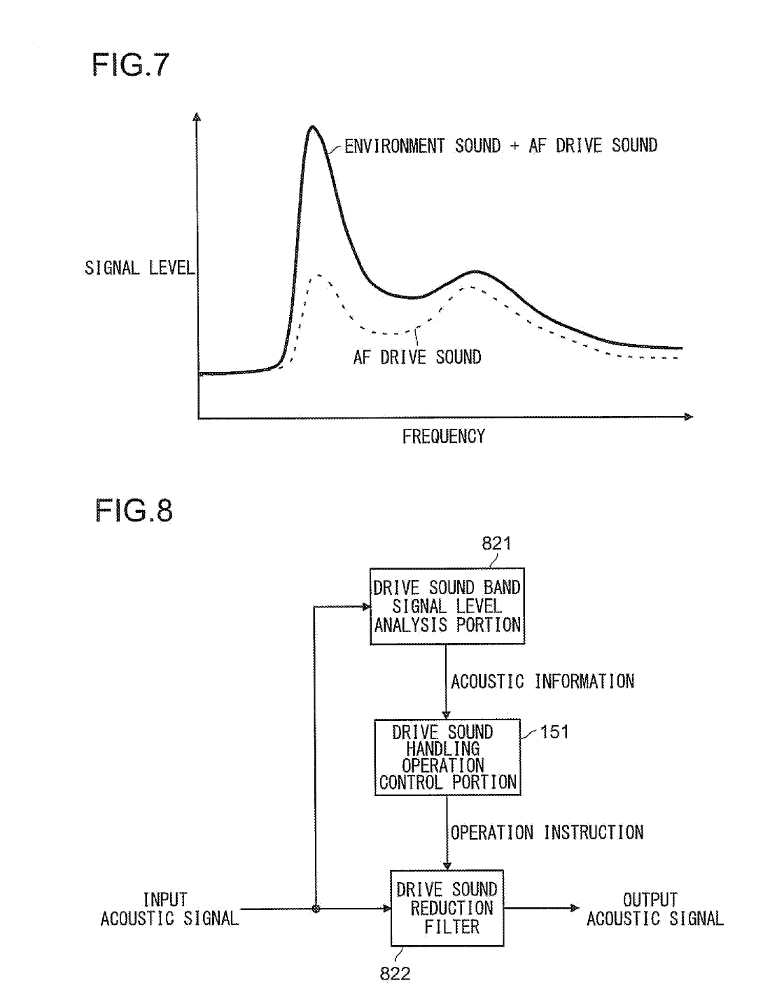

The AF drive sound will be described with reference to the drawing. FIG. 7 is a graph showing an example of the frequency characteristic of an acoustic signal at the time of execution of the AF. When the AF is executed, an acoustic signal (including an environment sound component and an AF drive sound component) having a characteristic shown in FIG. 7 is obtained. As shown in FIG. 7, in this example, an AF drive sound having a frequency characteristic in which a signal level in a predetermined frequency band (specifically, for example, 1 to 2 kHz) is high is assumed to be produced. It is also assumed that, in the frequency characteristic of the AF drive sound, a signal level and a frequency band having a high signal level are unlikely to vary.

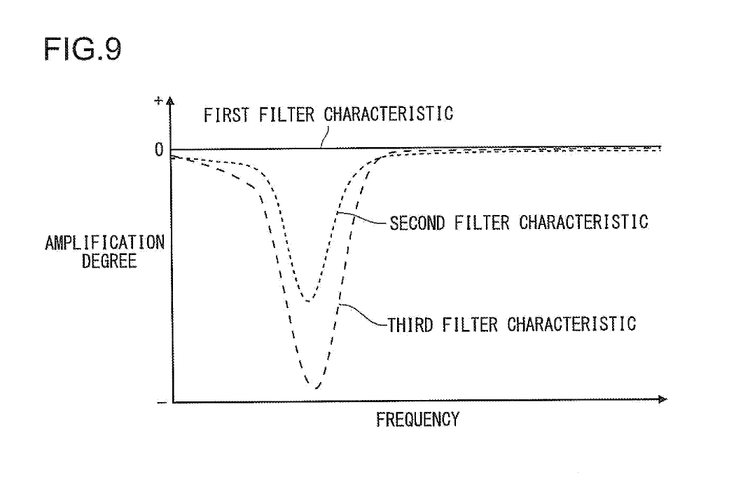

The drive sound handling operation of this example will be described with reference to accompanying drawings. FIG. 8 is a block diagram showing an example of the configuration or the function in which the drive sound handling operation of the second specific example (3) is performed; FIG. 9 is a graph showing the filter characteristic of filter processing that can be selected by the drive sound reduction filter of FIG. 8.

As shown in FIG. 8, the drive sound handling operation of this example is performed by: a drive sound band signal level analysis portion 821 that acquires the frequency characteristic of an acoustic signal (input acoustic signal) to be processed, analyzes the signal level in a predetermined frequency band and outputs it as the acoustic information; the drive sound handling operation control portion 151 described above; and a drive sound reduction filter 822 that acquires an acoustic signal (output acoustic signal) obtained by performing filter processing on the input acoustic signal with a filter characteristic corresponding to the operation instruction output from the drive sound handling operation control portion 151. The drive sound band signal level analysis portion 821 and the drive sound reduction filter 822 can be interpreted as part of the configuration or one function of the acoustic processing portion 8.

The drive sound band signal level analysis portion 821 performs the FFT processing or the like on the input acoustic signal to determine the frequency characteristic, and determines the signal level in a predetermined frequency band where the signal level of the AF drive sound is high and outputs it as the acoustic information.

The image sensing environment determination portion 1511 compares, in a predetermined frequency, the known (for example, prerecorded) signal level of the AF drive sound with the signal level of the acoustic signal obtained from the acoustic information Based on the result of the comparison, the image sensing environment determination portion 1511 determines which one of the types of filter processing that can be selected by the drive sound reduction filter 822 is an appropriate image sensing environment. The image sensing environment determination portion 1511 may determine the image sensing environment using the average value of the signal levels of the acoustic signals in a predetermined time period (for example, one second) as the signal level of the acoustic signal obtained from the acoustic information.

The drive sound reduction filter 822 can perform the filter processing by using, for example, any of first to third filter characteristics shown in FIG. 9. In the first filter characteristic, the amplification degree does not depend on the frequency, and thus is approximately zero. Hence, when the filter processing is performed with the first filter characteristic, the input acoustic signal can be obtained as the output acoustic signal substantially without being processed. In the second filter characteristic, the amplification degree in the predetermined frequency band described above is negative, and the amplification degree in the other frequencies is approximately zero. Hence, when the filter processing is performed with the second filter characteristic, the output acoustic signal in which a component in the frequency band where the AF drive sound in the input acoustic signal can be present is reduced can be obtained. In the third filter characteristic, as in the second filter characteristic, the amplification degree in the predetermined frequency band described above is negative, and the amplification degree in the other frequencies is approximately zero; however, the amplification degree in the predetermined frequency band is lower than that in the second filter characteristic (is larger in attenuation degree). Hence, when the filter processing is performed with the third filter characteristic, the output acoustic signal in which a component in the frequency band where the AF drive sound in the input acoustic signal can be present is significantly reduced can be obtained.

When the signal level of the acoustic signal in the predetermined frequency band is sufficiently higher than the signal level of the AF drive sound in the predetermined frequency band (for example, twice or more higher than), the image sensing environment determination portion 1511 determines that the filter processing with the first filter characteristic is an appropriate image sensing environment. This is because the drive sound component of the acoustic signal is embedded, and thus it is difficult for the user to recognize.

In this case, the operation determination portion 1512 outputs, to the drive sound reduction filter 822, an operation instruction to select the first filter characteristic.

When the signal level of the acoustic signal in the predetermined frequency band is somewhat higher than the signal level of the AF drive sound in the predetermined frequency band (for example, equal to or higher than but is less than twice higher than), the image sensing environment determination portion 1511 determines that the filter processing with the second filter characteristic is an appropriate image sensing environment. This is because the drive sound component of the acoustic signal is not significantly embedded, and thus it is easy for the user to recognize.

In this case, the operation determination portion 1512 outputs, to the drive sound reduction filter 822, an operation instruction to select the second filter characteristic.

When the signal level of the acoustic signal in the predetermined frequency band is lower than the signal level of the AF drive sound in the predetermined frequency band (for example, lower than), the image sensing environment determination portion 1511 determines that the filter processing with the third filter characteristic is an appropriate image sensing environment. This is because the drive sound component of the acoustic signal is unlikely to be embedded, and thus it is easy for the user to recognize.

In this case, the operation determination portion 1512 outputs, to the drive sound reduction filter 822, an operation instruction to select the third filter characteristic.

With the configuration described above, it is possible to reduce the possibility that the AF drive sound component of the acoustic signal is easily recognized by the user. It is also possible to reduce the possibility that the filter processing for reducing the AF drive sound component of the acoustic signal is performed more than necessary and that thus the acoustic signal is degraded.

Although, as the drive sound handling operation of this example, the filter processing for reducing the AF drive sound has been described as an example, the drive sound handling operation of this example can be applied to drive sound accompanying another operation of the image sensing device 1.

[Third Specific Example]

A third specific example of the drive sound handling operation will now be described. The third specific example of the drive sound handling operation relates to the drive speed of the optical portion 3 and a method of processing the image signal by the image processing portion 5. The third specific example is divided into examples (1) to (3), and the examples (1) to (3) will be individually described below. It is possible to combine the examples (1) to (3) and perform the combination unless a contradiction arises.

Third Specific Example: (1)

In the drive sound handling operation of this example, as in the first specific examples (1) to (4), the drive speed of the optical portion 3 is adaptively limited or controlled, and thus the effects of the drive sound on the acoustic signal are reduced. Furthermore, in the drive sound handling operation of this example, the method of processing the image signal is adaptively controlled, and thus the effects of the drive sound on the operability and the convenience of the image sensing device 1 are effectively reduced. For specific examples of the limitation and the control of the drive speed of the optical portion 3, the description of the first specific examples (1) to (4) can be referenced, and thus their description will be omitted. In order for specific description to be given, a case where, when the first zoom in is performed, the drive sound handling operation of this example is performed will be described as an example.

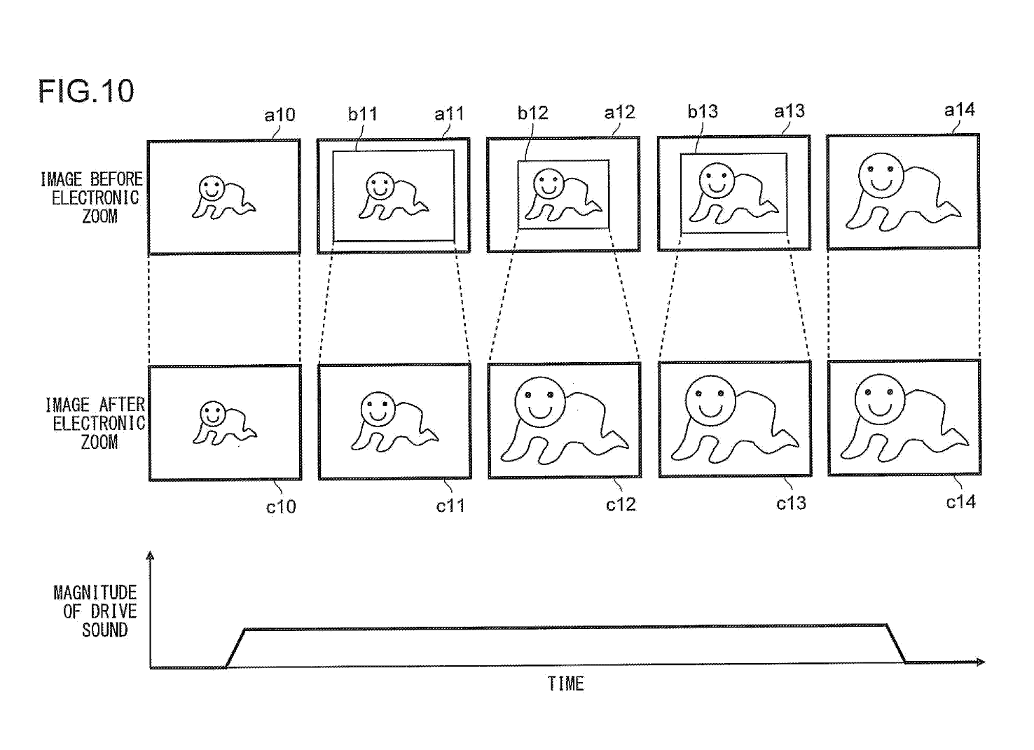

When, as a result of the drive speed of the optical portion 3 being limited or controlled, the drive speed is decreased, the operability and the convenience of the image sensing device 1 may be degraded. In this case, in this example, electronic zoom (for example, processing for changing the angle of view by enlarging a region of the image (increasing the number of pixels) through the interpolation of pixels or the like or reducing the image (decreasing the number of pixels) through the addition, the thinning-out or the like of pixels; the same is true in the following description) that is one of the methods of processing the image signal is applied, and thus the operability and the convenience of the image sensing device 1 are prevented from being degraded. An example of a case where the electronic zoom is applied will be described with reference to accompanying drawings. FIG. 10 is a diagram showing an example of the drive sound handing operation of the third specific example (1).

Images a10 to a14 of FIG. 10 are images before being subjected to the electronic zoom; the images a10 to a14 are obtained by being sensed in the following order: the image a10, the image a11, the image a12, the image a13 and the image a14. Images c10 to c14 are images obtained by performing the electronic zoom on each of the images a10 to a14. Regions b11 to b13 are regions in the images a11 to a13 whose angle of view is enlarged by the electronic zoom. The angle of view of the image a10 and the image c10 and the angle of view of the image a14 and the image c14 are substantially equal to each other. In other words, the images a10 and a14 can be interpreted as images whose angle of view is not enlarged by the electronic zoom.

In the example shown in FIG. 10, when the image c12 is obtained, its angle of view is assumed to become the angle of view desired by the user. Hence, for example, in the time period between when the image a10 is sensed and when the image a12 is sensed, the user instruction information indicating that the zoom in is to be performed is input to the operation determination portion 1512.

Here, the operation determination portion 1512 outputs, to the drive portion 21, an operation instruction to drive the optical portion 3 at a drive speed lower than the drive speed in which the operability and the convenience of the image sensing device 1 are unlikely to be degraded (for example, the drive speed most suitable for the operation of the image sensing device 1 by the user or the drive speed indicated by the user instruction information; hereinafter referred to as a target drive speed). In this way, in the time period between when the image a10 is sensed and when the image a12 is sensed, the optical portion 3 is driven and thus a small drive sound is produced.

Furthermore, the operation determination portion 1512 determines the speed of the electronic zoom (the size of the regions b11 and b12) and outputs it as the operation instruction to the image processing portion 5 such that an overall zoom speed (a speed obtained by adding the speed of the optical zoom by driving of the optical portion 3 to the speed of the electronic zoom; in other words, the apparent speed of zoom of the images c10 to c14 after the electronic zoom; the same is true in the following description) is substantially equal to the speed of the optical zoom when the optical portion 3 is driven at the target drive speed.

As described above, in this example, a lack produced by decreasing the drive speed of the optical portion 3 beyond the target drive speed so as to reduce the drive sound is compensated for by the speed of the electronic zoom of the same type as the optical zoom (of zoom in).

After the image a12 is sensed, the operation determination portion 1512 further drives the optical portion 3, and outputs, to the drive portion 21, an operation instruction to perform zoom in with the optical zoom. Simultaneously, the operation determination portion 1512 outputs, to the image processing portion 5, an operation instruction to perform zoom out with the electronic zoom. Here, control is preferably performed such that the overall zoom speed is substantially zero (the angles of view of the images c12 to c14 are substantially equal to each other) and that the image a14 whose angle of view is finally not enlarged by the electronic zoom is obtained, because it is possible to improve the degradation of the image while the angle of view is maintained. However, as shown in FIG. 10, in the time period between when the image a12 is sensed and when the image a14 is sensed, the optical portion 3 is driven and thus a small drive sound, for example, is produced.

With the configuration described above, it is possible to reduce the possibility that the drive sound component of the acoustic signal is easily recognized by the user. It is also possible to effectively reduce the possibility that the operability and the convenience of the image sensing device 1 are degraded.

In FIG. 10, when the angle of view of the image c12 desired by the user is obtained, the drive sound handling operation of this example may be completed. In other words, the images c13 and c14 may fail to be obtained (after the image c12 is obtained, the state of the electronic zoom is not changed).

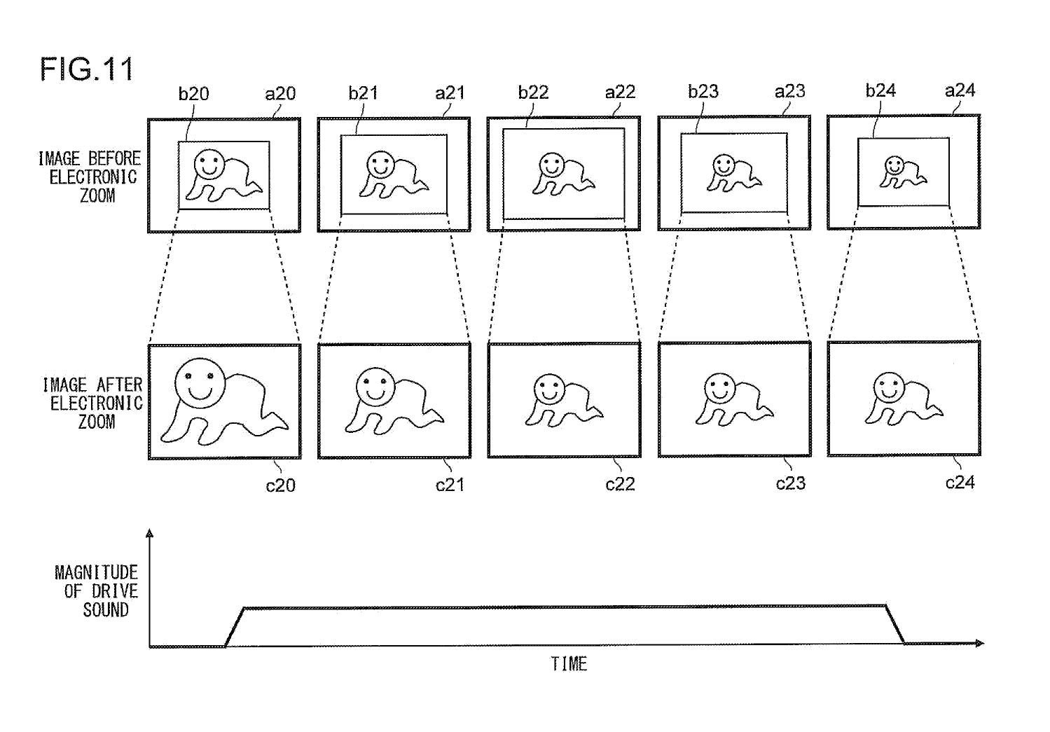

The drive sound handling operation of this example is not limited to zoom in; it can be applied to zoom out. An example of this case will be described with reference to the drawing. FIG. 11 is a diagram showing another example of the drive sound handling operation of the third specific example (1).

Images a20 to a24 of FIG. 11 are images before being subjected to the electronic zoom; the images a20 to a24 are obtained by being sensed in the following order: the image a20, the image a21, the image a22, the image a23 and the image a24. Images c20 to c24 are images obtained by performing the electronic zoom on each of the images a20 to a24. Regions b20 to b24 are regions in the images a20 to a24 whose angle of view is enlarged by the electronic zoom. When the image c22 is obtained, its angle of view is assumed to become the angle of view desired by the user.

In this example, the electronic zoom is performed on the image a20 when the zoom out is started, and the image c20 whose angle of view is equal to the region b20 is obtained. Hence, it is possible to perform the zoom out with the electronic zoom by increasing the region b21 beyond the region b20 or increasing the region b22 beyond the region b21. Thus, it is possible to compensate for a lack produced by decreasing the drive speed of the optical portion 3 beyond the target drive speed so as to reduce the drive sound, by the speed of the electronic zoom of the same type as the optical zoom (of zoom out).

As shown in FIG. 11, after the image a22 is sensed, the optical portion 3 is further driven to perform zoom out with the optical zoom, and simultaneously, zoom in may be performed with the electronic zoom. Here, the overall zoom speed is made substantially zero (the angles of view of the images c22 to c24 are made substantially equal to each other) and the image a24 in which the electronic zoom substantially equal to the image a20 at the time of start of zoom out is finally performed (in which the size of the region b24 is substantially equal to that of the region b20) may be obtained.

When the angle of view of the image c22 desired by the user is obtained, the drive sound handling operation of this example may be completed. In other words, the images c23 and c24 may fail to be obtained (after the image c22 is obtained, the state of the electronic zoom is not changed).

Third Specific Example: (2)

In the drive sound handling operation of this example, as in the first specific examples (3) to (5), the image sensing environment determination portion 1511 adaptively limits or controls the drive speed of the optical portion 3, and thus reduces the effects of the drive sound on the acoustic signal Furthermore, in the drive sound handling operation of this example, the method of processing the image signal is adaptively controlled, and thus the effects of the drive sound on the operability and the convenience of the image sensing device 1 are effectively reduced. For specific examples of the limitation and the control of the drive speed of the optical portion 3, the description of the first specific examples (3) and (5) can be referenced, and thus their description will be omitted. In order for specific description to be given, a case where, when the first zoom out is performed, the drive sound handling operation of this example is performed will be described as an example.

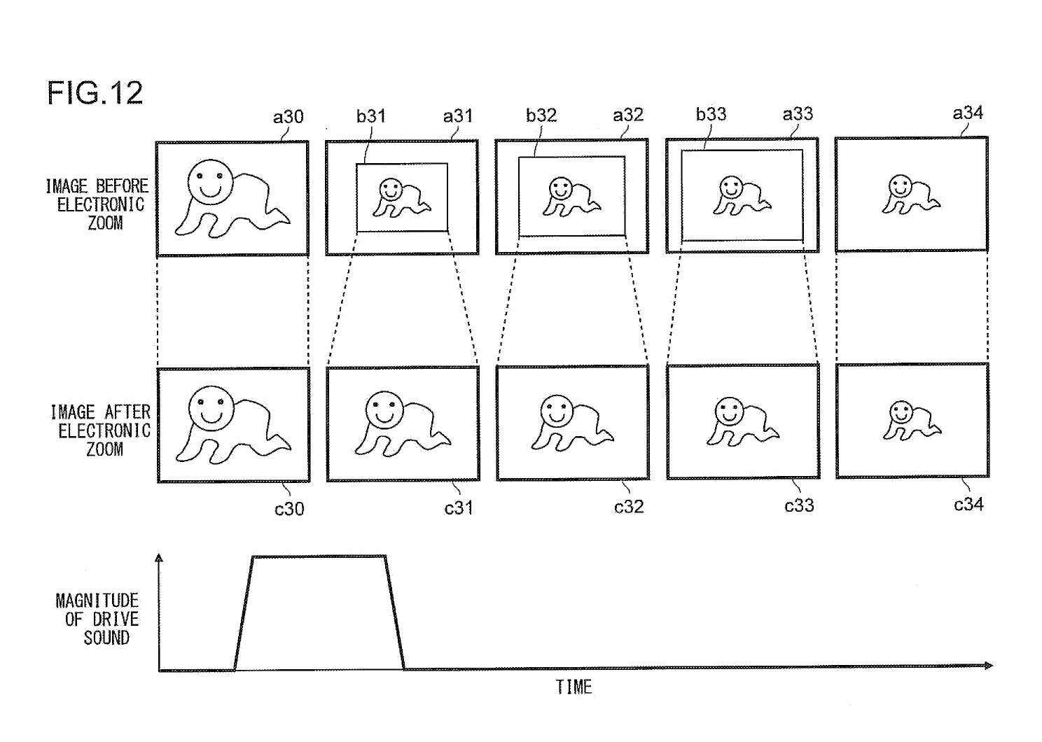

When, as a result of the drive speed of the optical portion 3 being limited or controlled, the drive speed is increased, the operability and the convenience of the image sensing device 1 may be degraded. In this case, in this example, electronic zoom that is one of the methods of processing the image signal is applied, and thus the operability and the convenience of the image sensing device 1 are prevented from being degraded. An example of a case where the electronic zoom is applied will be described with reference to accompanying drawings. FIG. 12 is a diagram showing an example of the drive sound handing operation of the third specific example (2).

Images a30 to a34 of FIG. 12 are images before being subjected to the electronic zoom; the images a30 to a34 are obtained by being sensed in the following order: the image a30, the image a31, the image a32, the image a33 and the image a34. Images c30 to c34 are images obtained by performing the electronic zoom on each of the images a30 to a34. Regions b31 to b33 are regions in the images a31 to a33 whose angle of view is enlarged by the electronic zoom. The angle of view of the image a30 and the image c30 and the angle of view of the image a34 and the image c34 are substantially equal to each other. In other words, the images a30 and a34 can be interpreted as images whose angle of view is not enlarged by the electronic zoom.

In the example shown in FIG. 12, when the image c34 is obtained, its angle of view is assumed to become the angle of view desired by the user. Hence, for example, in the time period between when the image a30 is sensed and when the image a34 is sensed, the user instruction information indicating that the zoom out is to be performed is input to the operation determination portion 1512.

Here, the operation determination portion 1512 outputs, to the drive portion 21, an operation instruction to drive the optical portion 3 at a drive speed higher than the target drive speed. In this way, in the time period between when the image a30 is sensed and when the image a31 is sensed, the optical portion 3 is driven and thus a large drive sound is produced.

Furthermore, the operation determination portion 1512 determines the speed of the electronic zoom (the size of the region b31) and outputs it as the operation instruction to the image processing portion 5 such that an overall zoom speed is substantially equal to the speed of the optical zoom when the optical portion 3 is driven at the target drive speed.

As described above, in this example, an excess produced by increasing the drive speed of the optical portion 3 beyond the target drive speed so as to reduce a time period in which the drive sound is produced is cancelled out by the speed of the electronic zoom of a different type from the optical zoom (of zoom in). Thereafter, a lack produced by decreasing the speed (in this example, zero) of the optical portion 3 beyond the target drive speed is compensated for by the speed of the electronic zoom of the same type as the optical zoom (of zoom out).

With the configuration described above, it is possible to reduce the possibility that the drive sound component of the acoustic signal is easily recognized by the user. It is also possible to effectively reduce the possibility that the operability and the convenience of the image sensing device 1 are degraded.

The large drive sound component of the acoustic signal produced by the drive sound handling operation of this example may be reduced by the method of each example of the second specific examples described above.

Even in the case where, when, for example, the image c32 is obtained before the image c34 is obtained, the angle of view becomes the angle of view desired by the user, an image whose angle of view is not enlarged by the electronic zoom may be finally obtained. In this case, after the image a32 is sensed, the operation determination portion 1512 outputs, to the drive portion 21, an operation instruction to further drive the optical portion 3 to perform zoom in with the optical zoom. Simultaneously, the operation determination portion 1512 outputs, to the image processing portion 5, an operation instruction to perform zoom out with the electronic zoom. Here, control is preferably performed such that the overall zoom speed is substantially zero, because it is possible to improve the degradation of the image while the angle of view is maintained. However, in the time period between when the image a32 is sensed and when the final image is sensed, the optical portion 3 is driven and thus a small drive sound, for example, is produced.

In this case, when the image c32 whose angle of view is desired by the user is obtained, the drive sound handling operation of this example may be completed (after the image c132 is obtained, the state of the electronic zoom may not be changed).

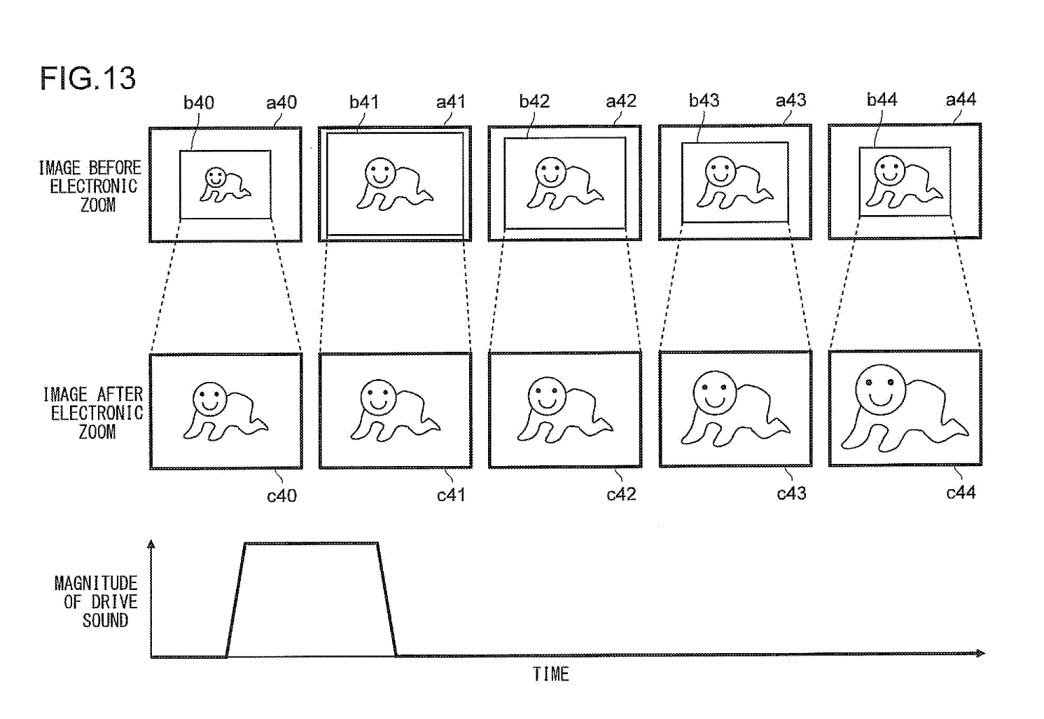

The drive sound handling operation of this example is not limited to zoom out; it can be applied to zoom in. An example of this case will be described with reference to the drawing. FIG. 13 is a diagram showing another example of the drive sound handling operation of the third specific example (2).

Images a40 to a44 of FIG. 13 are images before being subjected to the electronic zoom; the images a40 to a44 are obtained by being sensed in the following order: the image a40, the image a41, the image a42, the image a43 and the image a44. Images c40 to c44 are images obtained by performing the electronic zoom on each of the images a40 to a44. Regions b40 to b44 are regions in the images a40 to a44 whose angle of view is enlarged by the electronic zoom. When the image c42 is obtained, its angle of view is assumed to become the angle of view desired by the user.

In this example, the electronic zoom is performed on the image a40 when the zoom in is started, and the image c40 whose angle of view is equal to the region b40 is obtained. Hence, it is possible to perform the zoom out with the electronic zoom by increasing the region b41 beyond the region b40. Furthermore, thereafter, it is possible to perform the zoom in with the electronic zoom. Thus, it is possible to cancel out an excess produced by increasing the drive speed of the optical portion 3 beyond the target drive speed so as to reduce a time period in which the drive sound is produced, by the speed of the electronic zoom of a different type from the optical zoom (of zoom out). Moreover, thereafter, it is possible to compensate for a lack produced by decreasing the speed of the optical zoom (in this example, zero) beyond the target drive speed, by the speed of the electronic zoom of the same type as the optical zoom (of zoom in).

Even in the case where, when, for example, the image c42 is obtained before the image c44 is obtained, the angle of view becomes the angle of view desired by the user, an image in which an electronic zoom substantially equal to the image a40 at the time of start of zoom in is finally performed (the size of the region is substantially equal to the region b40) may be obtained. Here, after the image a42 is sensed, the optical portion 3 is further driven to perform zoom out with the optical zoom; simultaneously, zoom in may be performed with the electronic zoom. Here, the overall zoom speed may be made substantially zero. However, in the time period between when the image a42 is sensed and when the final image is sensed, the optical portion 3 is driven and thus a small drive sound, for example, is produced.

When the image c42 whose angle of view is desired by the user is obtained, the drive sound handling operation of this example may be completed (after the image c42 is obtained, the state of the electronic zoom may not be changed). The large drive sound component of the acoustic signal produced by the drive sound handling operation of this example may be reduced by the method of each example of the second specific examples described above.

Third Specific Example: (3)

In the drive sound handling operation of this example, for example, the drive speed (the speed of the optical zoom) of the optical portion 3 in the third specific examples (1) and (2) described above and the method of processing the image signal (the speed of the electronic zoom) by the image processing portion 5 are adaptively controlled, and thus the effects of the drive sound on the acoustic signal and the effects of the drive sound on the image signal are reduced. For specific examples of the drive speed of the optical portion 3 and the method of processing the image signal, the description of the third specific examples (1) and (2) can be referenced, and thus their description will be omitted.

Based on the input image information, the image sensing environment determination portion 1511 checks the magnitude of movement in the image and the brightness of the image. Specifically, for example, the image sensing environment determination portion 1511 checks the magnitude of the amount of change of the image and the brightness of the image. Here, for example, the image processing portion 5 outputs, as the image information, the magnitude of the amount of change of the image and the brightness value.

Based on the amount of change of the image and the brightness value, the image sensing environment determination portion 1511 determines which of the optical zoom and the electronic zoom is an appropriate image sensing environment. Based on the average value of the magnitude of the amount of change of the image in a predetermined time period (for example, one second) and the average value of the brightness value in a predetermined time period (for example, one second), the image sensing environment determination portion 1511 may determine the image sensing environment. Based on either of the magnitude of the amount of change of the image and the brightness value, the image sensing environment determination portion 1511 may determine the image sensing environment. Alternatively, based on the both, the image sensing environment determination portion 1511 may determine the image sensing environment.

As the amount of change of the image is increased or the brightness value is decreased, the image sensing environment determination portion 1511 determines that the optical zoom is an appropriate image sensing environment. This is because, as an image has a larger movement caused such as by camera shake or an image is darker, the degradation of the image caused by the electronic zoom is increased.

Hence, when, for example, the user instruction information indicating that zoom is to be performed is input, the operation determination portion 1512 preferentially applies the zoom (the optical zoom or the electronic zoom) suitable for the image sensing environment determined by the image sensing environment determination portion 1511. For example, an operation instruction to perform the optical zoom (the drive of the optical portion 3) at a speed determined based on the image sensing environment determined by the image sensing environment determination portion 1511 is output to the drive portion 21; an operation instruction to perform the electronic zoom at a speed determined based on the image sensing environment determined by the image sensing environment determination portion 1511 is output to the image processing portion 5.

Here, for example, the operation determination portion 1512 makes a determination such that, as the amount of change of the image is increased or the brightness value is decreased, the speed of the optical zoom is increased and the speed of the electronic zoon is decreased. The operation determination portion 1512 may make a determination such that, as the amount of change of the image is increased or the brightness value is decreased, the effects of the electronic zoom are reduced (the image is prevented from being enlarged through the interpolation of the pixel or the like).

With the configuration described above, it is possible to reduce the possibility that the drive sound component of the acoustic signal is easily recognized by the user. It is also possible to effectively reduce the possibility that the operability and the convenience of the image sensing device 1 are degraded. It is also possible to reduce the degradation of the image.

The image sensing environment determination portion 1511 may determine the image sensing environment based on the user instruction information in addition to (or instead of) the image information. In this case, the image sensing environment determination portion 1511 may determine, by the input of, for example, user instruction information (night view image sensing mode or animal image sensing mode) indicating that the image of a dark scene or an animal is to be sensed, that the optical zoom is an appropriate image sensing environment. The image sensing environment determination portion 1511 may determine, by the input of user instruction information (image sensing mode other than the night view image sensing mode and the animal image sensing mode) indicating that the image of anything other than a dark scene or an animal is to be sensed, that the electronic zoom is an appropriate image sensing environment.

<<Variations>>

At least two of the first average value, the third average value and the fourth average value described above may be calculated to be a common value. At least two of the first average value, the second average value and the fourth average value may be calculated to be the same value. The images shown in FIGS. 10 to 13 before and after the electronic zoom are images that simply represent the angle of view and that do not necessarily represent the size of the images (the number of pixels).

In the image sensing device 1 of the embodiment of the present invention, the operations of the image processing portion 5, the acoustic processing portion 8, the drive sound handling operation control portion 151 and the like may be performed by a control device such as a microcomputer. Furthermore, all or part of functions realized by such a control device are described as a program; the program is executed on a program execution device (for example, computer), and thus all or part of the functions may be realized.

Since they are not limited to what has been described above, the image sensing device 1 shown in FIG. 1, the drive sound handling operation control portion 151 shown in FIG. 3, the configuration or the function shown in FIG. 6 and the configuration or the function shown in FIG. 8 can be realized either by hardware or by a combination of hardware and software. When the image sensing device 1, the drive sound handling operation control portion 151, the configuration or the function shown in FIG. 6 and the configuration or part of the function shown in FIG. 8 are realized using software, the block of a unit realized by the software represents a functional block of its unit.

Although the embodiment of the present invention has been described above, the scope of the present invention is not limited to the embodiment. Many modifications are possible without departing from the spirit of the present invention.

What is claimed is:

1. An image sensing device comprising:
an optical portion that is driven to form an optical image in any state;
a sensor portion that acquires, as an image signal, the optical image formed by the optical portion;
a sound collection portion that acquires an acoustic signal by collecting sound;
an image sensing environment determination portion that determines an image sensing environment which is an environment under which the sensor portion acquires the image signal; and
an operation determination portion that determines, based on the image sensing environment determined by the image sensing environment determination portion, at least one of a drive speed of the optical portion and a method of processing the acoustic signal acquired by the sound collection portion when the optical portion is driven.

2. The image sensing device of claim 1,
wherein the image sensing environment determination portion determines the image sensing environment based on at least one of the acoustic signal, the image signal and an instruction input by a user, and
the operation determination portion determines, based on the image sensing environment determined by the image sensing environment determination portion, at least one of the drive speed of the optical portion and the method of processing the acoustic signal that reduces a drive sound component of the acoustic signal produced when the optical portion is driven.

3. The image sensing device of claim 2, further comprising:
an acoustic processing portion that processes the acoustic signal,
wherein, as the image sensing environment determination portion determines that a signal level of the acoustic signal is low, the operation determination portion makes a determination such that the acoustic processing portion significantly reduces the drive sound component from the acoustic signal.

4. The image sensing device of claim 2,
wherein, as the image sensing environment determination portion determines that a signal level of the acoustic signal is low and/or that a frequency characteristic of the acoustic signal is dissimilar to a frequency characteristic of the drive sound, the operation determination portion makes a determination such that the drive speed of the optical portion is decreased.

5. The image sensing device of claim 2,
wherein the operation determination portion determines the drive speed of the optical portion such that the frequency characteristic of the drive sound is similar to the frequency characteristic of the acoustic signal.

6. The image sensing device of claim 2, further comprising:
an image processing portion that acquires at least part of the image signal to produce a new image signal,
wherein the operation determination portion determines the drive speed of the optical portion and a magnitude of the part acquired by the image processing portion from the image signal such that an angle of view of the image indicated by the new image signal produced by the image processing portion is changed at a predetermined speed.
